(19) United States
(12) Patent Application Publication
(10) Pub. No.: US 2016/0050246 A1
(43) Pub. Date: Feb. 18, 2016

(54) QUALITY-AWARE RATE ADAPTATION TECHNIQUES FOR DASH STREAMING

(71) Applicant: INTEL IP CORPORATION, Santa Clara, CA (US)

(72) Inventors: Yiting Liao, Hillsboro, OR (US); Ozgur Oyman, San Jose, CA (US); Jeffery R Foerster, Portland, OR (US); Mohamed M. Rehan, Cairo (EG); Yomna Hassan, Cairo (EG)

(21) Appl. No.: 14/778,705

(22) PCT Filed: Dec. 20, 2013
(86) PCT No.: PCT/US2013/077142

§ 371 Date: Sep. 21, 2015

Related U.S. Application Data
(60) Provisional application No. 61/806,821, filed on Mar. 29, 2013.

(51) Int. Cl. H04L 29/06; H04L 29/08

(52) U.S. Cl. CPC H04L 65/4092; H04L 67/02; H04L 65/608; H04L 65/607

(57) ABSTRACT

A quality-aware rate adaptation algorithm is described to optimize the quality of experience (QoE) for a DASH client. Requesting media at a bitrate higher than the available network bandwidth can lead to re-buffering events that disrupt user experience, while requesting media at lower bitrates may lead to sub-optimum streaming quality. The quality-aware algorithm tries to optimize the QoE of a DASH client by maintaining a better trade-off between buffer levels and quality fluctuations.

### PRIORITY CLAIM

This application claims the benefit of priority to U.S. Provisional Patent Application Ser. No. 61/806,821, filed Mar. 29, 2013, which is incorporated herein by reference in its entirety.

### TECHNICAL FIELD

Embodiments described herein relate generally to wireless networks and communications systems.

### BACKGROUND

Dynamic Adaptive Streaming over HTTP (DASH) is a technology standardized in 3GPP TS26.247 of the 3rd Generation Partnership Project (3GPP) and MPEG ISO/IEC DIS 23009-1 of the Motion Picture Experts Group (MPEG). In DASH, the media presentation description (MPD) metadata file provides information on the structure and different versions of the media content stored in the server (including different bitrates, frame rates, resolutions, codec types, etc.). Based on this MPD metadata information, clients request segments of the media content using HTTP requests. The client fully controls the streaming session and may request different versions of the media content during playback.

An efficient rate adaptation algorithm is critical to optimize the quality of experience (QoE) for a DASH client. Requesting media at a bitrate higher than the available network bandwidth can lead to re-buffering events that disrupt user experience. Requesting media at lower bitrates, on the other hand, may lead to sub-optimum streaming quality. Described herein are techniques relating to advanced rate adaptation algorithms for DASH clients.

### BRIEF DESCRIPTION OF THE DRAWINGS

FIG. 1 illustrates an example of a DASH-based streaming framework.

FIG. 2 illustrates a client device communicating with a media server via an LTE network.

FIG. 3 illustrates a client device communicating with a media server via WLAN access to the internet.

### DETAILED DESCRIPTION

In DASH, media content is transferred from a media server that stores the media content to a client using segment-based HTTP streaming. The client plays back the media content as it is received. The media server may store the media content encoded in different versions that differ as to bitrates, resolutions, or other characteristics. Each different version of the media content is referred to as a representation. Each representation stored by the media server is divided into segments that can be accessed individually by the client via HTTP GET or partial GET requests. Each representation may thus consist of several segments of a particular length. The client is able to switch between different representations at segment boundaries during media playback to adjust the bitrate, resolution, or other characteristics. For example, the client may wish to decrease the bitrate and resolution when network conditions deteriorate. To direct the client in downloading the content, a manifest file called the media presentation description is downloaded from the server at the beginning of the steaming session. The MPD contains information relating to the bitrate, resolution, and/or other characteristics of each representation as well as the URLs (uniform resource locators) of the segments making up each representation. Segment formats may also be specified, which can contain information on initialization and media segments for a media engine to ensure mapping of segments into a media presentation timeline for switching and synchronous presentation with other representations. Based on the MPD metadata information, which describes the relationship of the segments and how the segments form a media presentation, a client requests the segments using an HTTP GET message or a series of partial GET messages. The client is able to control the streaming session by managing on-time requests to result in a smooth playback of a sequence of segments, adjusting bitrates or other attributes, and/or reacting to changes in a device state or a user preference.

Changing content, such as switching sports/static scenes in news channels makes it very difficult for video encoders to deliver consistent quality and at the same time produce a bitstream that has a certain specified bitrate. As a result, quality may fluctuate significantly. Quality-related information may be added to different encoded versions of various media components, and across segments and sub-segments of the various representations and sub-representations. The added quality information allows more advanced rate-adaptation algorithms for DASH clients. In addition to adapting media bitrate to network bandwidth, the DASH client may jointly consider requested video quality to optimize overall QoE of DASH streaming. The present disclosure proposes quality-aware rate adaptation principles and algorithms for DASH clients. To enable these advanced rate adaptation methods, quality information is added to the manifest file for adaptive HTTP streaming or is generated by the client.

Examples of a quality measures could include Video MS-SSIM (Multi-Scale Structural Similarity), video MOS (mean opinion score), video quality metrics (VQM), structural similarity metrics (SSIM), peak signal-to-noise ratio (PSNR), and perceptual evaluation of video quality metrics (PEVQ). This quality related information is then used to help determine the requested representation given the bandwidth constraints and quality requirements. In one embodiment, the quality related information is included in the MPD file and generated by the media server. The media server may acquire the information to compute the quality measures by analyzing the video content at the pixel level and/or extracting information from the codec during compression. The resulting quality measures are then signaled to the client via the MPD files, mapped by the client to subjective quality measures, and fed into the client's rate adaptation logic. In another embodiment, the client dynamically generates subjective quality information in a non-reference fashion based upon the received media files.

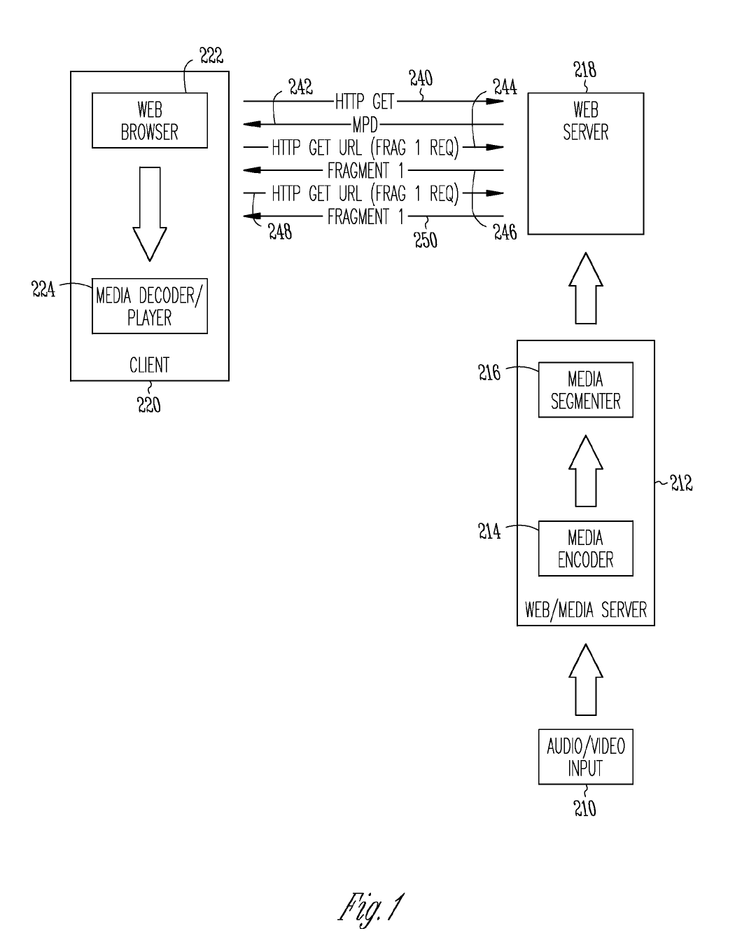

FIG. 1 illustrates an example of a DASH-based streaming framework. A media encoder 214 in the web/media server 212 is used encode an input media from an audio/video input 210 into a format for storage or streaming. A media segmenter 216 splits the input media into a serial of fragments or chunks which can then be provided to a web server 218 (e.g., an HTTP server). The client 220 requests new data in chunks using HTTP GET messages 234 sent to the web server 218. For example, a web browser 222 of the client 220 requests multimedia content using an HTTP GET message 240. The web server 218 then provides the client with an MPD 242 for the multimedia content. The MPD is used to convey the index of each segment and the segment's corresponding locations as shown in the associated metadata information. The web browser is then able to pull media from the server segment by segment in accordance with the MPD 242. As shown in the figure, the web browser can request a first fragment using a HTTP GET URL (frag 1 req) 244 where a uniform resource locator (URL) or universal resource indicator is used to tell the web server which segment the client requesting. The web server can then provide the first fragment (i.e., fragment 1 246). For subsequent fragments, the web browser requests a fragment i using a HTTP GET URL (frag i req) 248, where i is an integer index of the fragment. As a result, the web server provides a fragment i 250. The fragments are then presented to the client via a media decoder/player 224. The client may employ a quality-aware rate adaptation algorithm to determine which particular segments are requested from the web server.

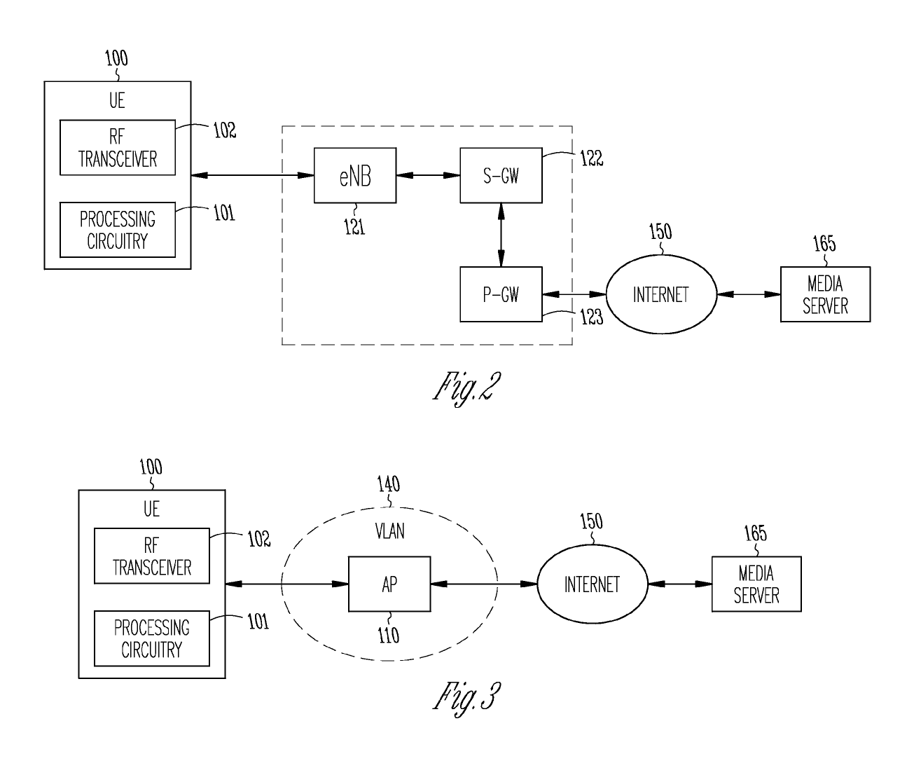

FIG. 2 illustrates an embodiment where the client is a UE (user equipment), referring to how terminals are designated in LTE (Long Term Evolution) cellular systems as set forth in the LTE specifications of the 3rd Generation Partnership Project (3GPP). In LTE, a terminal acquires cellular network access by connecting to a public land mobile network (PLMN) belonging to an operator or service provider. The connectivity to the PLMN is provided by a base station (referred in LTE systems as an evolved Node B or eNB). The UE 100 includes processing circuitry 101 and an RF (radio-frequency) transceiver for cellular network access. The processing circuitry includes the functionalities for network access via the RF transceiver as well as DASH client functionalities for requesting, receiving, buffering, and playing back (e.g., audio and/or video) media files received from a media server. The processing circuitry also includes functionality for performing any of the rate adaptation algorithms and methods as described herein.

In FIG. 2, the UE 100 communicates with eNB 121 of a PLMN 120 via an RF communications link, sometimes referred to as the LTE radio or air interface. The eNB 121 provides connectivity to the PLMN's evolved packet core (EPC), the main components of which (in the user plane) are S-GW 122 (serving gateway) and P-GW 123 (packet data network (PDN) gateway). The P-GW is the EPC's point of contact with the outside world and exchanges data with one or more packet data networks such as the internet 150, while the S-GW acts as a router between the eNB and P-GW. The UE is thus able to request and receive data from media server 165.

As the term is used herein, a UE may also be any type of terminal that is capable of acquiring network access, either cellular access as above in an LTE network, or otherwise such as via a WLAN (wireless local area network) such as a WiFi network. Many UEs are so-called dual-mode UEs that allow both cellular and WLAN access to be acquired. FIG. 3 shows another scenario where UE 100 acquires network access by connecting to an AP (access point) 110 of WLAN 140. The WLAN is able to provide connectivity to the internet 150 via direct internet access and enable the UE to request and receive data from media server 165.

A quality-aware rate adaptation method implemented by a client may incorporate any or all of the following features. It may estimate the dynamics of available network bandwidth to aid in which representation of a media file are to be selected. A sliding window may be used to measure the download rates at the client over a defined time interval. The sliding window may contain the download rate of previous duration for use in estimating the available download rate for the next segment. The client may control the buffer level and prevent buffering events that cause playback interruptions. The client may monitor the buffer level and switch the representation bitrates to avoid buffer underflow or overflow.

The client may try to maximize the overall quality of video stream under the bandwidth constraints and minimize the quality variations over time. Due to the changing characteristics of video content, the same representation index across different segments may correspond to different quality and bitrate values. The client may try to minimize the playback startup time. For example, after the requesting the DASH content, the rate adaptation may select content that result in starting the playback as fast as possible. The rate adaptation method may also act in a manner that provides good overall QoE and fairness across multiple DASH clients. DASH clients may simultaneously stream videos in the network and compete for the available bandwidth. The rate adaptation algorithm may also take into account the particular client device capabilities and adapt the bitrate based on the quality in different devices.

### Example Rate Adaptation Algorithm

An example quality-aware rate adaptation algorithm is described below using the following definitions:

R(r, s): bitrate of representation r for segment s, r=1, 2, ..., m; s=1, 2,

..., n, where R(1, s) < R(2, s) < ... < R(m, s)

Q(r, s): quality of representation r for segment s
BW(s): Available throughput in the past for segment s
BWₑₛₜ(s): Estimated throughput for current segment s
buf(t): Buffer level at time t, measured in seconds of playback
B_{low} and B_{high}: Lower and upper buffer level thresholds, respectively,

measured in, for example, seconds of playback

Qₘₐₓ(d) and Qₘᵢₙ(d): Maximum and minimum quality levels,

respectively, required for a particular device d

r(s): The representation to be selected for download for segment s,

where r(s) ε [1, m]

The quality-aware algorithm tries to optimize the QoE of a DASH client by maintaining a better trade-off between buffer levels and quality fluctuations. The algorithm determines, for each segment making up the media presentation, which particular representation is to be downloaded. That is, it determines:

r(s), for s=1,2,3, . . . ,n

where n is the number of segments in the media presentation.

At the startup phase, the algorithm selects the lowest bitrate representation for the first Nₛ segments in order to minimize the playback delay:

r(s)=argminᵣ((Q(r,s)>Qₘᵢₙ); r=1, . . . m; s=1, . . . Nₛ;

where Nₛ is a specified integer, r(s) is the representation r to be selected for media segment s, rε[1, m], m is the number of representations available for media segment s, Q(r,s) is the quality of representation r for segment s, and Qₘᵢₙ is a specified minimum quality requirement.

After a particular segment s−1 is downloaded, available throughput for segment s−1 is estimated as BW(s−1), and the estimated throughput for the next segment s is then determined as a weighted sum of the past K segments throughput:

$${BW}_{est} ( s ) = {\sum }_{i = 1}^{K} w ( i ) BW ( s - i )$$

where K is a specified integer and the w(i) are specified weighting factors.

For each segment s, the algorithm determines the lowest bitrate representation that satisfies the minimum quality requirement for the current device as:

r_{qmin}(s)=argminᵣ((Q(r,s)>Qₘᵢₙ),

determines is the lowest bitrate representation that satisfies the maximum quality requirement for current device as:

r_{qmax}(s)=argminᵣ((Q(r,s)>Qₘₐₓ),

and determines the highest bitrate representation under the current throughput constraints as:

rᵣₘₐₓ(s)=argmaxᵣ((R(r,s)<BWₑₛₜ(s).

As the media file is downloaded, the client buffers the data. The amount of data stored in the client's buffer is then used to determine the selected representation for current segment s that is to be downloaded. At the beginning of streaming, the DASH client enters the buffering state and the lowest bitrate representation is requested, expressed as:

if buf(t)≈0, then: r(s)=r(1,s), s=1, . . . N

When the buffer level is low, the client performs more conservatively and tries to either request a representation with a bitrate lower than the available throughput or meet the minimum quality requirement. This may be expressed as:

if buf(t)<B_{low}, then: r(s)=min(r_{qmin}(s),rᵣₘₐₓ(s))

When the buffer level is under a safe level, the client tries not to request a representation higher than the available throughput unless the minimum quality requirement cannot be met. This may be expressed as:

if B_{low}≦buf(t)<B_{high}, then: r(s)=min(max(r_{qmin}(s),rᵣₘₐₓ(s)),r_{qmax}(s))

When the buffer level is high, the client performs more aggressively and can request a representation with a bitrate higher than the available throughput in order to meet the maximum quality requirement. This may be expressed as:

if buf(t)≧B_{high} and R(r_{qmax}(s),s)<αBWₑₛₜ(s), then: r(s)=r_{qmax}(s), and

if buf(t)≧B_{high} and R(r_{qmax}(s),s)>αBWₑₛₜ(s) then: r(s)=max(r_{qmin}(s),rᵣₘₐₓ(s)),

where α is a specified number such that a larger a indicates the client performs more aggressively.

### Additional Notes and Examples

In Example 1, a method for receiving DASH (dynamic streaming over HTTP (hypertext transfer protocol)) data in a client device over a network, comprises: receiving a media presentation description (MPD) from an HTTP server, wherein the MPD contains uniform resource identifiers (URIs) for a media presentation made up of a plurality of ordered media segments, and wherein, for each of the ordered media segments, the MPD contains URIs for the same media content at different bitrates, referred to as representations, and includes for each representation a bitrate and a quality measure related to the quality of experience (QoE) that results when that representation is played; and, downloading selected representations for playback at designated playback times from the HTTP server using the URIs in the MPD, wherein representations received before their designated playback times are stored in a buffer, and wherein representations are selected for downloading as a function of the amount of data currently stored in the buffer, the bitrates and quality measures of the representations, and an estimated currently available throughput capacity.

In Example 2, a method for receiving DASH (dynamic streaming over HTTP (hypertext transfer protocol)) data in a client device over a network, comprises: receiving a media presentation description (MPD) from an HTTP server, wherein the MPD contains uniform resource identifiers (URIs) for a media presentation made up of a plurality of ordered media segments, and wherein, for each of the ordered media segments, the MPD contains URIs for the same media content at different bitrates, referred to as representations, and includes for each representation a bitrate; and, downloading selected representations for playback at designated playback times from the HTTP server using the URIs in the MPD, wherein representations received before their designated playback times are stored in a buffer; generating quality measures related to the quality of experience (QoE) that results when representations are played; and selecting representations for downloading as a function of the amount of data currently stored in the buffer, the bitrates and quality measures of the representations, and an estimated currently available throughput capacity.

In Example 3, the subject matters of either of Example 1 or Example 2 may optionally include computing an estimated throughput capacity BWₑₛₜ(s) for a particular media segment s as a weighted sum of the throughputs of previously downloaded media segments such that:

$${BW}_{est} ( s ) = {\sum }_{i = 1}^{K} w ( i ) BW ( s - i )$$

where BW(s) is the actual throughput corresponding to media segment s and K is a specified integer.

In Example 4, the subject matters of either of Example 1 or Example 2 may optionally include, for a media segment s, selecting a representation r(s) for downloading with the lowest bitrate when buf(t)=0 where buf(t) is a measure of the amount of data stored in the buffer at time t and corresponds to a particular duration of playback.

In Example 5, the subject matters of either of Example 1 or Example 2 may optionally include, when buf(t)<B_{low}, where buf(t) is a measure of the amount of data stored in the buffer at time t corresponding to a particular duration of playback and where B_{low} is a specified buffer level, selecting a representation r(s) to be downloaded for media segment s as:

r(s)=min(r_{qmin}(s),rᵣₘₐₓ(s))

where r_{qmin}(s) is the lowest bitrate representation that satisfies a specified minimum quality requirement Qₘᵢₙ expressed as:

r_{qmin}(s)=argminᵣ((Q(r,s)>Qₘᵢₙ),

where rᵣₘₐₓ(s) is the highest bitrate representation under current throughput constraints expressed as:

rᵣₘₐₓ(s)=argmaxᵣ((R(r,s)<BWₑₛₜ(s),

where Q(r,s) is the quality measure of representation r for media segment s, and where R(r,s) is the bitrate of representation r for media segment s.

In Example 6, the subject matters of either of Example 1 or Example 2 may optionally include, when B_{low}≦buf(t)<B_{high}, where buf(t) is a measure of the amount of data stored in the buffer at time t corresponding to a particular duration of playback and where B_{low} and B_{high} are specified buffer levels, selecting a representation r(s) to be downloaded for media segment s as:

r(s)=min(max(r_{qmin}(s),rᵣₘₐₓ(s)),r_{qmax}(s))

where r_{qmin}(s) is the lowest bitrate representation that satisfies a specified minimum quality requirement Qₘᵢₙ expressed as:

r_{qmin}(s)=argminᵣ((Q(r,s)>Qₘᵢₙ),

where rᵣₘₐₓ(s) is the highest bitrate representation under current throughput constraints expressed as:

rᵣₘₐₓ=argmaxᵣ((R(r,s)<BWₑₛₜ(s),

where r_{qmax}(s) is the lowest bitrate representation that satisfies a specified maximum quality requirement Qₘₐₓ expressed as:

r_{qmax}(s)=argminᵣ((Q(r,s)>Qₘₐₓ),

where Q(r,s) is the quality measure of representation r for media segment s, and
where R(r,s) is the bitrate of representation r for media segment s.

In Example 7, the subject matters of either of Example 1 or Example 2 may optionally include, when B_{high}≦buf(t), where buf(t) is a measure of the amount of data stored in the buffer at time t corresponding to a particular duration of playback and where B_{high} is a specified buffer level, selecting a representation r(s) to be downloaded for media segment s as:

r(s)=r_{qmax}(s) if R(r_{qmax}(s),s)<αBWₑₛₜ(s)

and as

r(s)=max(r_{qmin}(s),rᵣₘₐₓ(s)) if R(r_{qmax}(s),s)>αBWₑₛₜ(s)

where α is a specified parameter greater than one, where r_{qmin}(s) is the lowest bitrate representation that satisfies a specified minimum quality requirement Qₘᵢₙ expressed as:

r_{qmin}(s)=argminᵣ((Q(r,s)>Qₘᵢₙ),

where rᵣₘₐₓ(s) is the highest bitrate representation under current throughput constraints expressed as:

rᵣₘₐₓ(s)=argmaxᵣ((R(r,s)<BWₑₛₜ(s),

where r_{qmax}(s) is the lowest bitrate representation that satisfies a specified maximum quality requirement Qₘₐₓ expressed as:

r_{qmax}(s)=argminᵣ((Q(r,s)>Qₘₐₓ),

where Q(r,s) is the quality measure of representation r for media segment s, and where R(r,s) is the bitrate of representation r for media segment s.

In Example 8, the subject matters of either of Example 1 or Example 2 may optionally include wherein the quality measure is selected from a group that includes Video MS-SSIM (Multi-Scale Structural Similarity), video MOS (mean opinion score), video quality metrics (VQM), structural similarity metrics (SSIM), peak signal-to-noise ratio (PSNR), and perceptual evaluation of video quality metrics (PEVQ).

In Example 9, the subject matters of either of Example 1 or Example 2 may optionally include, at the beginning of playback, requesting the representation with the lowest bitrate that meets a minimum quality requirement for the first N representations in order minimize playback delay, where N is a specified integer, such that:

r(s)=argminᵣ((Q(r,s)>Qₘᵢₙ); r=1, . . . m; s=1, . . . N;

where r(s) is the representation r to be selected for media segment s, r ε[1, m], is the number of representations available for media segment s, Q(r,s) is the quality of representation r for segment s, and Qₘᵢₙ is a specified minimum quality requirement.

In Example 10, the subject matters of either of Example 1 or Example 2 may optionally include receiving the DASH data over a wireless network.

In Example 11, a user equipment (UE) device for operating in an LTE (Long Term Evolution) network, comprises: processing circuitry including a buffer and a radio transceiver; wherein the processing circuitry is to perform any of the methods as set forth in Examples 1 through 10.

In Example 12, a computer-readable medium contains instructions for performing any of the methods as set forth in Examples 1 through 10.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The embodiments as described above may be implemented in various hardware configurations that may include a processor for executing instructions that perform the techniques described. Such instructions may be contained in a machine-readable medium such as a suitable storage medium or a memory or other processor-executable medium.

The embodiments as described herein may be implemented in a number of environments such as part of a wireless local area network (WLAN), 3rd Generation Partnership Project (3GPP) Universal Terrestrial Radio Access Network (UTRAN), or Long-Term-Evolution (LTE) or a Long-Term-Evolution (LTE) communication system, although the scope of the invention is not limited in this respect. An example LTE system includes a number of mobile stations, defined by the LTE specification as User Equipment (UE), communicating with a base station, defined by the LTE specifications as an eNodeB.

Antennas referred to herein may comprise one or more directional or omnidirectional antennas, including, for example, dipole antennas, monopole antennas, patch antennas, loop antennas, microstrip antennas or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, antennas may be effectively separated to take advantage of spatial diversity and the different channel characteristics that may result between each of antennas and the antennas of a transmitting station. In some MIMO embodiments, antennas may be separated by up to 1/10 of a wavelength or more.

In some embodiments, a receiver as described herein may be configured to receive signals in accordance with specific communication standards, such as the Institute of Electrical and Electronics Engineers (IEEE) standards including IEEE 802.11-2007 and/or 802.11(n) standards and/or proposed specifications for WLANs, although the scope of the invention is not limited in this respect as they may also be suitable to transmit and/or receive communications in accordance with other techniques and standards. In some embodiments, the receiver may be configured to receive signals in accordance with the IEEE 802.16-2004, the IEEE 802.16(e) and/or IEEE 802.16(m) standards for wireless metropolitan area networks (WMANs) including variations and evolutions thereof, although the scope of the invention is not limited in this respect as they may also be suitable to transmit and/or receive communications in accordance with other techniques and standards. In some embodiments, the receiver may be configured to receive signals in accordance with the Universal Terrestrial Radio Access Network (UTRAN) LTE communication standards. For more information with respect to the IEEE 802.11 and IEEE 802.16 standards, please refer to “IEEE Standards for Information Technology—Telecommunications and Information Exchange between Systems”—Local Area Networks—Specific Requirements—Part 11 “Wireless LAN Medium Access Control (MAC) and Physical Layer (PHY), ISO/IEC 8802-11: 1999”, and Metropolitan Area Networks—Specific Requirements Part 16: “Air Interface for Fixed Broadband Wireless Access Systems,” May 2005 and related amendments/versions. For more information with respect to UTRAN LTE standards, see the 3rd Generation Partnership Project (3GPP) standards for UTRAN-LTE, release 8, March 2008, including variations and evolutions thereof.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F.R. §1.72(b) in the United States of America. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1.-23. (canceled)

24. A method for receiving DASH (dynamic streaming over HTTP (hypertext transfer protocol)) data in a client device over a network, comprising:
receiving a media presentation description (MPD) from an HTTP server, wherein the MPD contains uniform resource identifiers (URIs) for a media presentation made up of a plurality of ordered media segments, and wherein, for each of the ordered media segments, the MPD contains URIs for the same media content at different bitrates, referred to as representations, and includes for each representation a bitrate and a quality measure related to the quality of experience (QoE) that results when that representation is played; and,
downloading selected representations for playback at designated playback times from the HTTP server using the URIs in the MPD, wherein representations received before their designated playback times are stored in a buffer, and wherein representations are selected for downloading as a function of the amount of data currently stored in the buffer, the bitrates and quality measures of the representations, and an estimated currently available throughput capacity.

25. The method of claim 24 further comprising, at the beginning of playback, requesting the representation with the lowest bitrate that meets a minimum quality requirement for the first N representations in order minimize playback delay, where N is a specified integer, such that:
r(s)=argminᵣ((Q(r,s)>Qₘᵢₙ); r=1, . . . m; s=1, . . . N;
where r(s) is the representation r to be selected for media segment s, rε[1, m], m is the number of representations available for media segment s, Q(r,s) is the quality of representation r for segment s, and Qₘᵢₙ is a specified minimum quality requirement.

26. The method of claim 24 further comprising computing an estimated throughput capacity BWₑₛₜ(s) for a particular media segment s as a weighted sum of the throughputs of previously downloaded media segments such that:
$${BW}_{est} ( s ) = {\sum }_{i = 1}^{K} w ( i ) BW ( s - i )$$
where BW(s) is the actual throughput corresponding to media segment s and K is a specified integer.

27. The method of claim 24 further comprising, for a media segment s, selecting a representation r(s) for downloading with the lowest bitrate when buf(t)=0 where buf(t) is a measure of the amount of data stored in the buffer at time t and corresponds to a particular duration of playback.

28. The method of claim 26 further comprising, when buf(t)<B_{low}, where buf(t) is a measure of the amount of data stored in the buffer at time t corresponding to a particular duration of playback and where B_{low} is a specified buffer level, selecting a representation r(s) to be downloaded for media segment s as:
r(s)=min(r_{qmin}(s),rᵣₘₐₓ(s))
where r_{qmin}(s) is the lowest bitrate representation that satisfies a specified minimum quality requirement Qₘᵢₙ expressed as:
r_{qmin}(s)=argminᵣ((Q(r,s)>Qₘᵢₙ),
where rᵣₘₐₓ(s) is the highest bitrate representation under current throughput constraints expressed as:
rᵣₘₐₓ(s)=argmaxᵣ((R(r,s)<BWₑₛₜ(s),
where Q(r,s) is the quality measure of representation r for media segment s, and where R(r,s) is the bitrate of representation r for media segment s.

29. The method of claim 26 further comprising, when B_{low}≦buf(t)<B_{high}, where buf(t) is a measure of the amount of data stored in the buffer at time t corresponding to a particular duration of playback and where B_{low} and B_{high} are specified buffer levels, selecting a representation r(s) to be downloaded for media segment s as:
r(s)=min(max(r_{qmin}(s),rᵣₘₐₓ(s)),r_{qmax}(s))
where r_{qmin}(s) is the lowest bitrate representation that satisfies a specified minimum quality requirement Qₘᵢₙ expressed as:
r_{qmin}(s)=argminᵣ((Q(r,s)>Qₘᵢₙ),
where rᵣₘₐₓ(s) is the highest bitrate representation under current throughput constraints expressed as:
rᵣₘₐₓ(s)=argmaxᵣ((R(r,s)<BWₑₛₜ(s),
where r_{qmax}(s) is the lowest bitrate representation that satisfies a specified maximum quality requirement Qₘₐₓ expressed as:
r_{qmax}(s)=argminᵣ((Q(r,s)>Qₘₐₓ),
where Q(r,s) is the quality measure of representation r for media segment s, and where R(r,s) is the bitrate of representation r for media segment s.

30. The method of claim 26 further comprising, when B_{high}≦buf(t), where buf(t) is a measure of the amount of data stored in the buffer at time t corresponding to a particular duration of playback and where B_{high} is a specified buffer level, selecting a representation r(s) to be downloaded for media segment s as:
r(s)=r_{qmax}(s) if R(r_{qmax}(s),s)<αBWₑₛₜ(s)
and as
r(s)=max(r_{qmin}(s),rᵣₘₐₓ(s)) if R(r_{qmax}(s),s)>αBWₑₛₜ(s)
where α is a specified parameter greater than one, where r_{qmin}(s) is the lowest bitrate representation that satisfies a specified minimum quality requirement Qₘᵢₙ expressed as:
r_{qmin}(s)=argminᵣ((Q(r,s)>Qₘᵢₙ),
where rᵣₘₐₓ(s) is the highest bitrate representation under current throughput constraints expressed as:
rᵣₘₐₓ(s)=argmaxᵣ((R(r,s)<BWₑₛₜ(s),
where r_{qmax}(s) is the lowest bitrate representation that satisfies a specified maximum quality requirement Qₘₐₓ expressed as:
r_{qmax}(s)=argminᵣ((Q(r,s)>Qₘₐₓ),
where Q(r,s) is the quality measure of representation r for media segment s, and where R(r,s) is the bitrate of representation r for media segment s.

31. The method of claim 24 further comprising:
selecting a representation r(s) to be downloaded for media segment s as:
r(s)=min(r_{qmin}(s),rᵣₘₐₓ(s))
if buf(t)<B_{low};
selecting a representation r(s) to be downloaded for media segment s as:
r(s)=min(max(r_{qmin}(s),rᵣₘₐₓ(s)),r_{qmax}(s))
if B_{low}≦buf(t)<B_{high};
selecting a representation r(s) to be downloaded for media segment s as:
r(s)=r_{qmax}(s) if R(r_{qmax}(s),s)<αBWₑₛₜ(s)
and as
r(s)=max(r_{qmin}(s),rᵣₘₐₓ(s)) if R(r_{qmax}(s),s)>αBWₑₛₜ(s)
if B_{high}≦buf(t);
where buf(t) is a measure of the amount of data stored in the buffer at time t corresponding to a particular duration of playback, where B_{high} and B_{low} are specified buffer levels, where BWₑₛₜ(s) is an estimated throughput capacity computed for a particular media segment s as a weighted sum of the throughputs of previously downloaded media segments such that:
$${BW}_{est} ( s ) = {\sum }_{i = 1}^{K} w ( i ) BW ( s - i )$$
where BW(s) is the actual throughput corresponding to media segment s and K is a specified integer, where r_{qmin}(s) is the lowest bitrate representation that satisfies a specified minimum quality requirement Qₘᵢₙ expressed as:
r_{qmin}(s)=argminᵣ((Q(r,s)>Qₘᵢₙ),
where rᵣₘₐₓ(s) is the highest bitrate representation under current throughput constraints expressed as:
rᵣₘₐₓ(s)=argmaxᵣ((R(r,s)<BWₑₛₜ(s),
where r_{qmax}(s) is the lowest bitrate representation that satisfies a specified maximum quality requirement Qₘₐₓ expressed as:
r_{qmax}(s)=argminᵣ((Q(r,s)>Qₘₐₓ),
where Q(r,s) is the quality measure of representation r for media segment s, and where R(r,s) is the bitrate of representation r for media segment s.

32. The method of claim 24 wherein the quality measure is selected from a group that includes Video MS-SSIM (Multi-Scale Structural Similarity), video MOS (mean opinion score), video quality metrics (VQM), structural similarity metrics (SSIM), peak signal-to-noise ratio (PSNR), and perceptual evaluation of video quality metrics (PEVQ).

33. The method of claim 24 further comprising receiving the DASH data over a wireless network.

34. A method for receiving DASH (dynamic streaming over HTTP (hypertext transfer protocol)) data in a client device over a network, comprising:
receiving a media presentation description (MPD) from an HTTP server, wherein the MPD contains uniform resource identifiers (URIs) for a media presentation made up of a plurality of ordered media segments, and wherein, for each of the ordered media segments, the MPD contains URIs for the same media content at different bitrates, referred to as representations, and includes for each representation a bitrate; and,
downloading selected representations for playback at designated playback times from the HTTP server using the URIs in the MPD, wherein representations received before their designated playback times are stored in a buffer;
generating quality measures related to the quality of experience (QoE) that results when representations are played; and
selecting representations for downloading as a function of the amount of data currently stored in the buffer, the bitrates and quality measures of the representations, and an estimated currently available throughput capacity.

35. The method of claim 34 further comprising, at the beginning of playback, requesting the representation with the lowest bitrate that meets a minimum quality requirement for the first N representations in order minimize playback delay, where N is a specified integer, such that:
r(s)=argminᵣ((Q(r,s)>Qₘᵢₙ); r=1, . . . m; s=1, . . . N;
where r(s) is the representation r to be selected for media segment s, rε[1, m], m is the number of representations available for media segment s, Q(r,s) is the quality of representation r for segment s, and Qₘᵢₙ is a specified minimum quality requirement.

36. The method of claim 34 further comprising computing an estimated throughput capacity BWₑₛₜ(s) for a particular media segment s as a weighted sum of the throughputs of previously downloaded media segments such that:
$${BW}_{est} ( s ) = {\sum }_{i = 1}^{K} w ( i ) BW ( s - i )$$
where BW(s) is the actual throughput corresponding to media segment s and K is a specified integer.

37. The method of claim 34 further comprising, for a media segment s, selecting a representation r(s) for downloading with the lowest bitrate when buf(t)=0 where buf(t) is a measure of the amount of data stored in the buffer at time t and corresponds to a particular duration of playback.

38. The method of claim 36 further comprising, when buf(t)<B_{low}, where buf(t) is a measure of the amount of data stored in the buffer at time t corresponding to a particular duration of playback and where B_{low} is a specified buffer level, selecting a representation r(s) to be downloaded for media segment s as:
r(s)=min(r_{qmin}(s),rᵣₘₐₓ(s))
where r_{qmin}(s) is the lowest bitrate representation that satisfies a specified minimum quality requirement expressed as:
r_{qmin}(s)=argminᵣ((Q(r,s)>Qₘᵢₙ),
where rᵣₘₐₓ(s) is the highest bitrate representation under current throughput constraints expressed as:
rᵣₘₐₓ(s)=argmaxᵣ((R(r,s)<BWₑₛₜ(s),
where Q(r,s) is the quality measure of representation r for media segment s, and where R(r,s) is the bitrate of representation r for media segment s.

39. The method of claim 36 further comprising, when B_{low}≦buf(t)<B_{high}, where buf(t) is a measure of the amount of data stored in the buffer at time t corresponding to a particular duration of playback and where B_{low} and B_{high} are specified buffer levels, selecting a representation r(s) to be downloaded for media segment s as:
r(s)=min(max(r_{qmin}(s),rᵣₘₐₓ(s)),r_{qmax},(s))
where r_{qmin}(s) is the lowest bitrate representation that satisfies a specified minimum quality requirement Qₘᵢₙ expressed as:
r_{qmin}(s)=argminᵣ((Q(r,s)>Qₘᵢₙ),
where rᵣₘₐₓ(s) is the highest bitrate representation under current throughput constraints expressed as:
rᵣₘₐₓ(s)=argmaxᵣ((R(r,s)<BWₑₛₜ(s),
where r_{qmax}(s) is the lowest bitrate representation that satisfies a specified maximum quality requirement Qₘₐₓ expressed as:
r_{qmax}(s)=argminᵣ((Q(r,s)>Qₘₐₓ),
where Q(r,s) is the quality measure of representation r for media segment s, and where R(r,s) is the bitrate of representation r for media segment s.

40. The method of claim 36 further comprising, when B_{high}≦buf(t), where buf(t) is a measure of the amount of data stored in the buffer at time t corresponding to a particular duration of playback and where B_{high} is a specified buffer level, selecting a representation r(s) to be downloaded for media segment s as:
r(s)=r_{qmax}(s) if R(r_{qmax}(s),s)<αBWₑₛₜ(s)
and as
r(s)=max(r_{qmin}(s),rᵣₘₐₓ(s)) if R(r_{qmax}(s),s)>αBWₑₛₜ(s)
where α is a specified parameter greater than one, where r_{qmin}(s) is the lowest bitrate representation that satisfies a specified minimum quality requirement Qₘᵢₙ expressed as:
r_{qmin}(s)=argminᵣ((Q(r,s)>Qₘᵢₙ),
where rᵣₘₐₓ(s) is the highest bitrate representation under current throughput constraints expressed as:
rᵣₘₐₓ(s)=argmaxᵣ((R(r,s)<BWₑₛₜ(s),
where r_{qmax}(s) is the lowest bitrate representation that satisfies a specified maximum quality requirement Qₘₐₓ expressed as:
r_{qmax}(s)=argminᵣ((Q(r,s)>Qₘₐₓ),
where Q(r,s) is the quality measure of representation r for media segment s, and where R(r,s) is the bitrate of representation r for media segment s.

41. The method of claim 34 further comprising:
selecting a representation r(s) to be downloaded for media segment s as:
r(s)=min(r_{qmin}(s),rᵣₘₐₓ(s))
if buf(t)<B_{low};
selecting a representation r(s) to be downloaded for media segment s as:
r(s)=min(max(r_{qmin}(s),rᵣₘₐₓ(s)),r_{qmax}(s))
if B_{low}≦buf(t)<B_{high};
selecting a representation r(s) to be downloaded for media segment s as:
r(s)=r_{qmax}(s) if R(r_{qmax}(s),s)<αBWₑₛₜ(s)
and as
r(s)=max(r_{qmin}(s),rᵣₘₐₓ(s)) if R(r_{qmax}(s),s)>αBWₑₛₜ(s)
if B_{high}≦buf(t);
where buf(t) is a measure of the amount of data stored in the buffer at time t corresponding to a particular duration of playback, where B_{high} and B_{low} are specified buffer levels, where BWₑₛₜ(s) is an estimated throughput capacity computed for a particular media segment s as a weighted sum of the throughputs of previously downloaded media segments such that:
$${BW}_{est} ( s ) = {\sum }_{i = 1}^{K} w ( i ) BW ( s - i )$$
where BW(s) is the actual throughput corresponding to media segment s and K is a specified integer, where r_{qmin}(s) is the lowest bitrate representation that satisfies a specified minimum quality requirement Qₘᵢₙ expressed as:
r_{qmin}(s)=argminᵣ((Q(r,s)>Qₘᵢₙ),
where rᵣₘₐₓ(s) is the highest bitrate representation under current throughput constraints expressed as:
rᵣₘₐₓ(s)=argmaxᵣ((R(r,s)<BWₑₛₜ(s),
where r_{qmax}(s) is the lowest bitrate representation that satisfies a specified maximum quality requirement Qₘₐₓ expressed as:
r_{qmax}(s)=argminᵣ((Q(r,s)>Qₘₐₓ),
where Q(r,s) is the quality measure of representation r for media segment s, and where R(r,s) is the bitrate of representation r for media segment s.

42. A user equipment (UE) device for operating in an LTE (Long Term Evolution) network, comprising:
processing circuitry including a buffer and a radio transceiver;
wherein the processing circuitry is to:
receive a media presentation description (MPD) from an HTTP server, wherein the MPD contains uniform resource identifiers (URIs) for a media presentation made up of a plurality of ordered media segments, and wherein, for each of the ordered media segments, the MPD contains URIs for the same media content at different bitrates, referred to as representations, and includes for each representation a bitrate and a quality measure related to the quality of experience (QoE) that results when that representation is played; and,
download selected representations for playback at designated playback times from the HTTP server using the URIs in the MPD, wherein representations received before their designated playback times are stored in a buffer, and wherein representations are selected for downloading as a function of the amount of data currently stored in the buffer, the bitrates and quality measures of the representations, and an estimated currently available throughput capacity.

43. The device of claim 42 wherein the processing circuitry is to compute an estimated throughput capacity BWₑₛₜ(s) for a particular media segment s as a weighted sum of the throughputs of previously downloaded media segments such that:
$${BW}_{est} ( s ) = {\sum }_{i = 1}^{K} w ( i ) BW ( s - i )$$
where BW(s) is the actual throughput corresponding to media segment s and K is a specified integer.

44. The device of claim 43 wherein the processing circuitry is to, when buf(t)<B_{low}, where buf(t) is a measure of the amount of data stored in the buffer at time t corresponding to a particular duration of playback and where B_{low} is a specified buffer level, select a representation r(s) to be downloaded for media segment s as:
r(s)=min(r_{qmin}(s),rᵣₘₐₓ(s))
where r_{qmin}(s) is the lowest bitrate representation that satisfies a specified minimum quality requirement Qₘᵢₙ expressed as:
r_{qmin}(s)=argminᵣ((Q(r,s)>Qₘᵢₙ),
where rᵣₘₐₓ(s) is the highest bitrate representation under current throughput constraints expressed as:
rᵣₘₐₓ(s)=argmaxᵣ((R(r,s)<BWₑₛₜ(s),
where Q(r,s) is the quality measure of representation r for media segment s, and where R(r,s) is the bitrate of representation r for media segment s.
